(19) United States
(12) Patent Application Publication
(10) Pub. No.: US 2025/0272182 A1
(43) Pub. Date: Aug. 28, 2025

(54) COMPUTING ENVIRONMENT REMEDIATION BASED ON TRAINED LEARNING MODELS

(71) Applicant: Dell Products L.P., Round Rock, TX (US)

(72) Inventors: Parminder Singh Sethi, Ludhiana (IN); Lakshmi Saroja Nalam, Bangalore (IN); Sirisha Karnam, Bangalore (IN)

(21) Appl. No.: 18/586,874

(22) Filed: Feb. 26, 2024

(51) Int. Cl. G06F 11/07; H04L 41/16; H04L 41/22

(52) U.S. Cl. CPC G06F 11/0793; H04L 41/16; H04L 41/22

(57) ABSTRACT

An apparatus includes at least one processing device comprising a processor coupled to a memory, wherein the at least one processing device is configured to receive data corresponding to operation of at least one device and one or more device components, and predict, using a plurality of machine learning models, a future operational state of the at least one device, at least one impact of the future operational state, and at least one trend associated with the at least one impact, wherein the predictions are based at least in part on the received data. A remediation plan for the at least one device is generated based at least in part on the predictions.

### FIELD

The field relates generally to information processing, and more particularly to managing information processing systems.

### BACKGROUND

Enterprises, such as original equipment manufacturers (OEMs), typically strive to provide ongoing technical support for their customers after their equipment is deployed at customer sites. For example, in the case of an OEM that manufactures electronic devices (e.g., servers, storage arrays, etc.) that are installed or otherwise reside at a customer site (e.g., customer data center), such devices are monitored by the enterprise using software modules (agents) deployed on the devices or by using some other remote monitoring tool. These agents or tools collect data from the devices either on demand, in an alert-based manner, and/or at periodic intervals. In the case of agents, the data (e.g., which can include data about the device as a whole and/or information about one or more components of the device) is sent from the agents installed on these devices to the enterprise, where it is analyzed, and reports are generated therefrom.

### SUMMARY

Illustrative embodiments provide techniques for generating a remediation plan for a computing environment based on trained learning models.

In one illustrative embodiment, an apparatus includes at least one processing device comprising a processor coupled to a memory, wherein the at least one processing device is configured to receive data corresponding to operation of at least one device and one or more device components, and predict, using a plurality of machine learning models, a future operational state of the at least one device, at least one impact of the future operational state, and at least one trend associated with the at least one impact, wherein the predictions are based at least in part on the received data. A remediation plan for the at least one device is generated based at least in part on the predictions.

These and other illustrative embodiments include, without limitation, methods, apparatus, networks, systems and processor-readable storage media.

### BRIEF DESCRIPTION OF THE DRAWINGS

FIG. 1 shows an information processing system environment with remediation plan generation functionalities according to an illustrative embodiment.

FIG. 2 shows a multi-stage process for remediation plan generation according to an illustrative embodiment.

FIG. 3 shows an operational flow for device state and impact prediction according to an illustrative embodiment.

FIG. 4 shows an operational flow for time series forecasting in connection with remediation plan generation according to an illustrative embodiment.

FIG. 5 shows an operational flow for remediation plan generation according to an illustrative embodiment.

FIG. 6 shows a remediation plan generation methodology according to an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the terms “information processing system” and “information processing system environment” as used herein are intended to be broadly construed, so as to encompass, for example, processing systems comprising cloud computing and storage systems, as well as other types of processing systems comprising various combinations of physical and virtual processing resources. An information processing system environment may therefore comprise, for example, at least one data center, as well as a computing platform operatively coupled to the data center. For example, in some illustrative embodiments, an information processing system environment may include an enterprise computing environment (e.g., a computing platform) operatively coupled to a customer computing environment (e.g., a data center), wherein the customer computing environment comprises one or more devices installed and/or supported by the enterprise.

As used herein, “application programming interface (API)” or “interface” refers to a set of subroutine definitions, protocols, and/or tools for building software. Generally, an API defines communication between software components. APIs permit programmers to write software applications consistent with an operating environment or website. APIs are used to integrate and pass data between applications, and may be implemented on top of other systems.

As mentioned, an enterprise (e.g., an OEM) utilizes software modules (e.g., agents) to monitor devices that the enterprise previously installed or otherwise supports in a customer computing environment (e.g., one or more data centers or the like). For example, data is sent from the agents installed on these devices to the enterprise. The data is analyzed, and reports are generated therefrom. However, in existing approaches, reports are typically generated using a static template from the analyzed data without considering factors such as: (i) impact on the customer computing environment due to degraded performance of the device; (ii) impact on the customer computing environment due to unavailability of devices; (iii) increased carbon footprint; and/or (iv) benefit(s) to the customer computing environment by considering a remediation plan.

Illustrative embodiments address these and other technical issues by analyzing the data obtained from the agents or other monitoring tools, generating a network topology for the monitored devices, and learning health status of the monitored devices. Then, a feature set from the data is auto encoded and models are trained. With the trained models, customer context-aware impact(s) is computed and a context-aware remediation plan is generated. The remediation plan can then be sent to the customer.

More particularly, illustrative embodiments gather and analyze data from the devices to determine the network topology, train a device state chain model, a device state impact model, and a fix state impact model. These models are used to determine the impact of a device state and of improvements to the device state to the customer computing environment or ecosystem. Then, a customer computing environment aware (e.g., context-aware) report is generated. For example, in some illustrative embodiments, a report may comprise information indicative of the availability of the device(s) exhibiting technical issues (e.g., faulty firmware and system basic input/output system (BIOS)), the impact of such device(s) on dependent devices in the environment, and the impact on consumers of the devices. By adapting or otherwise adhering to the report (i.e., a remediation plan), the customer computing environment can advantageously operate with improved performance and reduced downtime.

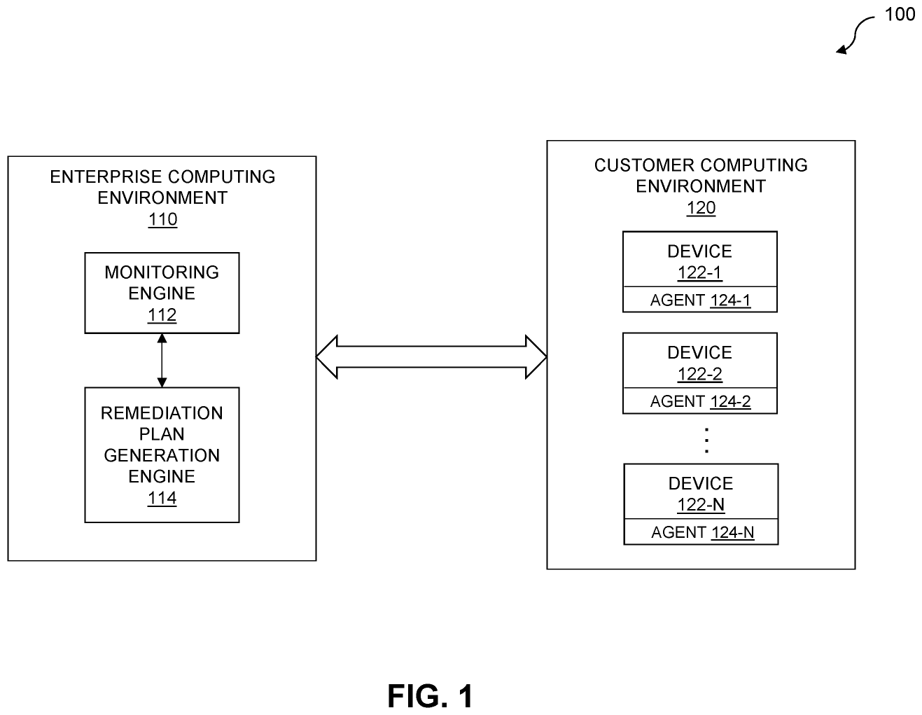

FIG. 1 shows an information processing system 100 with remediation plan generation functionalities according to an illustrative embodiment. As shown, an enterprise computing environment 110 is operatively coupled to a customer computing environment 120. In some embodiments, customer computing environment 120 is remote from (e.g., geographically or from an access perspective) enterprise computing environment 110 and communicates with the enterprise computing environment 110 over at least on network. The network is assumed to comprise a global computer network such as the Internet, although other types of networks can be part of the network, including a wide area network (WAN), a local area network (LAN), a satellite network, a telephone or cable network, a cellular network, a wireless network such as a WiFi or WiMAX network, or various portions or combinations of these and other types of networks.

Enterprise computing environment 110 includes a monitoring engine 112 and a remediation plan generation engine 114. As further shown, customer computing environment 120 includes devices 122-1, 122-2, . . . , 122-N(collectively referred to herein as devices 122 or individually as device 122) which are assumed to be electronic devices (e.g., servers, storage arrays, laptops, etc.) that have been installed and/or otherwise supported by the enterprise (e.g., OEM) associated with enterprise computing environment 110. The devices 122 may comprise physical and virtual computing resources. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc. Such devices 122 are examples of what are more generally referred to herein as “processing devices.” Some of these processing devices are also generally referred to herein as “computers.” Although not explicitly shown in FIG. 1, one or more input-output devices such as keyboards, displays (video monitors) or other types of input-output devices (e.g., mouse, etc.) may be used to support one or more user interfaces to the devices 122.

Devices 122-1, 122-2, . . . , 122-N respectively include agents 124-1, 124-2, . . . , 124-N (collectively referred to herein as agents 124 or individually as agent 124) resident thereon. Each agent 124 may be a software module configured to collect data about the corresponding device 122 either on demand, in an alert-based manner, and/or at periodic intervals. Each agent may comprise and utilize one or more APIs. The collected data may, for example, include data about the device 122 as a whole and/or information about one or more components of the device 122. Examples of collected data include, but are not necessarily limited to, central processing unit (CPU) utilization, memory consumption, drive (e.g., hard disk drive (HDD)) usage, device model, drive model, memory model and memory size (e.g., 16 GB, 32 GB, 64 GB, 128 GB, etc.). Some examples of device model data include, but are not necessarily limited to, server generation and server type (e.g., modular monolithic).

The data collected by the agents 124 is received as telemetry data (e.g., operational data) by monitoring engine 112 of enterprise computing environment 110. As will be further described herein, remediation plan generation engine 114 analyzes the telemetry data obtained from the agents 124, generates a network topology for the devices 122, and learns health status of the devices 122. Then, a feature set from the data is auto encoded and models are trained by remediation plan generation engine 114. With the trained models, customer context-aware impact(s) is computed, and a context-aware remediation plan is generated by remediation plan generation engine 114.

The remediation plan generation engine 114 in the FIG. 1 embodiment is assumed to be implemented using at least one processing device. Each such processing device generally comprises at least one processor and an associated memory, and implements one or more functional modules or logic for controlling certain features of the remediation plan generation engine 114. In some embodiments, one or more of the storage systems utilized to implement the associated memory comprise a scale-out all-flash content addressable storage array or other type of storage array.

The term “storage system” as used herein is intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Before describing functionalities of remediation plan generation engine 114 according to illustrative embodiments, some examples of existing report generation in a non-limiting customer data center example will first be described.

In the non-limiting customer data center example, assume devices that are sold to a customer are monitored by the OEM using agents that are installed on the devices or using some other remote monitoring tool. The agents collect the telemetry data from the devices either on demand, in an alert-based manner, and/or at periodic intervals. Assuming the devices are servers installed by an OEM (e.g., Dell Technologies Inc.), one non-limiting example of agents respectively deployed on the servers may include remote access controllers referred to as Integrated Dell Remote Access Controllers (iDRACs). Other examples of agents may include OpenManage Server Administrator (MSA) and/or SupportAssist, which are both software-based management modules commercially available from Dell Technologies Inc. However, remediation plan embodiments are not limited to any particular type of agents or other remote monitoring tools.

In existing approaches, telemetry data collected is analyzed, and reports are generated, for example, with the following information: device model; device components (e.g., hard drive, memory, motherboard etc.); dispatch units (e.g., the count of dispatches within 90 days per account/company); extra dispatch rate (e.g., the percentage of increase in dispatches as compared to defined threshold values); and active server units (e.g., the count of devices that are currently active in the data center/customer computing environment). By way of example, a dispatch may refer to an order and delivery of one or more additional (or replacement) components or devices for the customer computing environment. Each dispatch burdens the enterprise and its information technology (IT) and/or operational technology (OT) infrastructures needed to accommodate each dispatch.

Unfortunately, such existing reports are generated with a static template from the analyzed telemetry data without considering the following factors such as: (i) impact on the customer computing environment due to degraded performance of the device; (ii) impact on the customer computing environment due to unavailability of devices; (iii) increased carbon footprint; and/or (iv) benefit(s) to the customer computing environment by considering a remediation plan.

As such, there is significant resource waste when a customer does not know or take into account the impact caused by the dispatches that are necessitated to keep the customer's data center operational at a required/desired performance level. For example, assume an account XYZ has 1228 active devices with the model “Server 123.” Assume further that the enterprise has provided extra dispatches with the rate of 248% in 90 days. These extra dispatches are due to the server components (e.g., hard drive, memory, etc.) having a non-supported/lower version of drive firmware and/or system BIOS, and/or an error/faulty component state. Thus, for account XYZ, the enterprise must bear a significant extra dispatch burden cost. As will be explained, illustrative embodiments overcome this and other technical problems by generating a customer environment context-aware remediation plan.

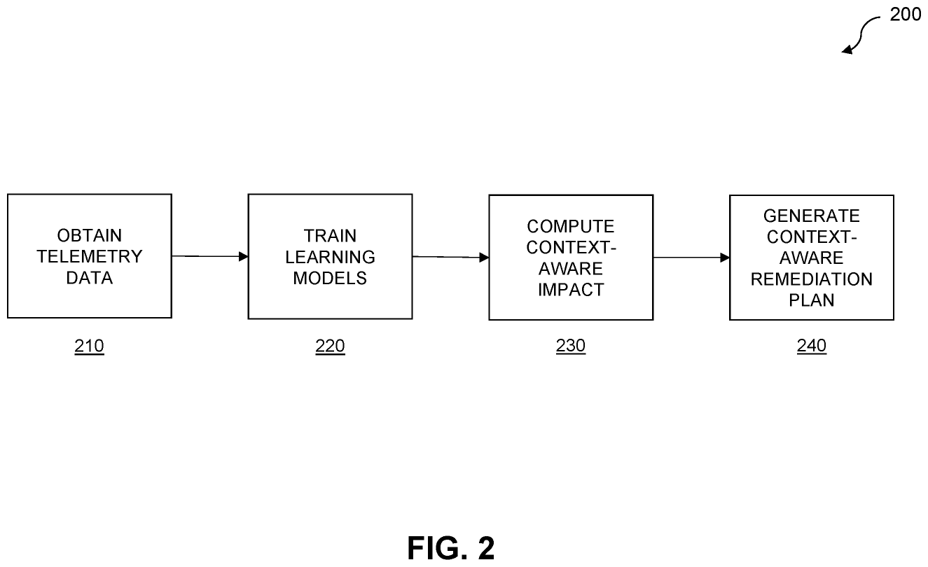

Referring now to FIG. 2, a multi-stage process (i.e., process 200) for remediation plan generation according to an illustrative embodiment is shown. It is to be appreciated that process 200 can be implemented by remediation plan generation engine 114 as mentioned above in the context of FIG. 1. As shown, process 200 includes obtaining telemetry data (stage 210), training learning models (stage 220), computing context-aware impact (stage 230), and generating a context-aware remediation plan (stage 240). Each stage of process 200 in FIG. 2 will be described in further detail below with occasional reference back to FIG. 1.

Stage 210: Obtain telemetry data.

The telemetry data is received by monitoring engine 112 from device 122 collected using agents 124 installed on devices 122 as explained above. Monitoring engine 112 can receive this information periodically, on-demand, and/or in an alert-based manner. Monitoring engine 112 can gather this information using one or more commercially available applications such as, by way of example only, Lightning, Streamliner, Service Now, Issue Management, etc. Monitoring engine 112 can check warranty details of devices 122, and the received data can be pushed to one or more tables (stored by monitoring engine 112 or elsewhere in enterprise computing environment 110) for access, for a selected time period, by remediation plan generation engine 114 for further analysis. Thus, remediation plan generation engine 114 can obtain one or more portions of the telemetry data from monitoring engine 112 in stage 210.

Stage 220: Train learning models.

More particularly, stage 220 learns from the obtained telemetry data, which can be considered as historical data, and trains a plurality of machine learning models for detection and prediction, as will be explained. In illustrative embodiments, the data available from stage 210 is categorized into a set of parameters which are auto encoded and provided to a hybrid machine learning model as a set of features. The hybrid machine learning model comprises a plurality of machine learning models. By way of example only, the set of features may include: (i) CPU utilization; (ii) memory consumption; (iii) drive usage; (iv) device model including, for example, server generation and server type; (v) drive model; (vi) memory model and (vii) memory size.

In some embodiments, stage 220 performs analysis using the above features to train a Markov chain machine learning model to predict device states. A Markov chain is a stochastic machine learning model that describes a sequence of events in which the probability of each event depends only on the state attained in the previous event. In other words, the next device state is dependent only on the current device state. The Markov chain model is trained with the above-mentioned features.

In a non-limiting illustrative embodiment, a Markov chain model is used to predict future state probabilities. Markov chain analysis uses a current device state to predict a next device state, and does not consider device states prior to the current state or how the current state was reached. In an operational example using Markov analysis, a stochastic machine learning model is used to predict respective probabilities of one or more future operational states of the at least one device based on a most recent known operational state of the at least one device. For example, the future state is predicted without depending on the details on how a device 122 or its components reached its present state. For example, a device is in a first state S1 at time T1, a second state S2 at time T2 and third state S3 at time T3. Using Markov analysis, the device state S3 at time T3 is only dependent on the device state S2 at time T2, and device state S1 at time T1 is irrelevant. In other words, only the most recent point (most recent device state) in the trajectory affects the next point (next state).

At stage 220, a multiple linear regression machine learning model and a time series machine learning model are also trained with the above features. In illustrative embodiments, the multiple linear regression machine learning model and/or time series forecasting machine learning model predicts at least one impact of the future operational state determined by the Markov chain model. In illustrative embodiments, the time series machine learning model predicts the at least one trend associated with the at least one impact determined by the multiple linear regression machine learning model. The time series forecasting machine learning model can comprise an autoregressive integrated moving average (ARIMA) machine learning model. The set of features used for training comprises non-stationary time series data. In training the ARIMA machine learning model, the remediation plan generation engine 114 converts the non-stationary time series data to stationary time series data, and trains the ARIMA machine learning model with the stationary time series data.

Stage 230: Compute context-aware impact.

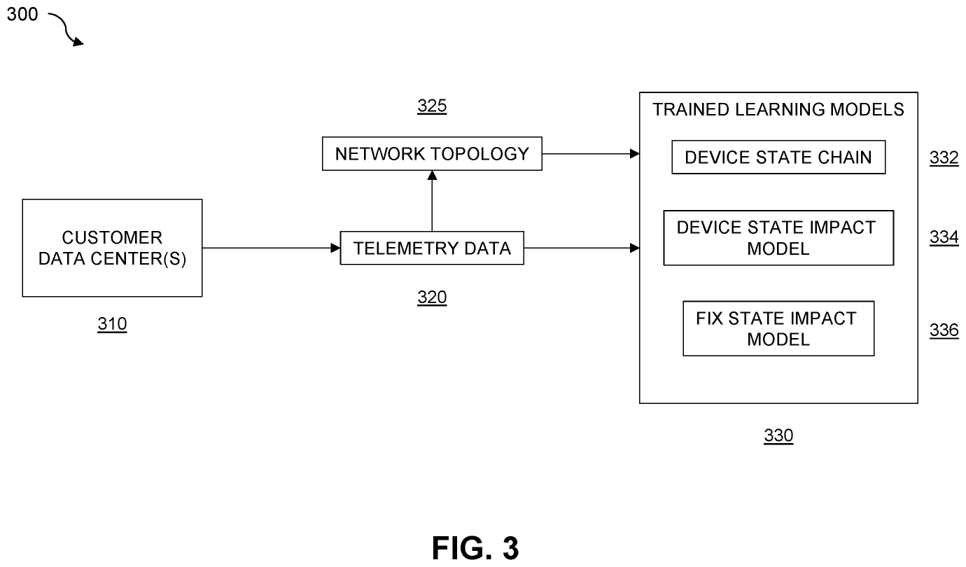

Referring to FIG. 2 and to the operational flow 300 for device state and impact prediction in FIG. 3, the trained learning models 330 include a device state chain model 332 (e.g., Markov chain machine learning model), a device state impact model 334 (e.g., multiple linear regression machine learning model and/or time series forecasting model) and a fix state impact model 336 (e.g., multiple linear regression machine learning model and/or time series forecasting machine learning model). Telemetry data 320 collected from devices (e.g., devices 122) in a customer data center 310 is provided to the trained learning models 330. The customer data center 310 is an example of a customer computing environment 120, and the trained learning models 330 may be part of the remediation plan generation engine 114.

The telemetry data 320 can be collected via the monitoring engine 112 using the agents 124. The remediation plan generation engine 114 analyzes the telemetry data 320 to determine a network topology 325 of the customer data center 310. Based on, for example, device identifiers, location identifiers, connection port identifiers, network identifiers, bus identifiers, protocols, etc., the remediation plan generation engine 114 can identify how components and devices of the customer data center 310 ac interconnected (e.g., device A is connected to switch SW and is connected to storage array E). Once the network topology 325 is identified, the remediation plan generation engine 114 generates a visualization of the network topology 325 based on the telemetry data 320. The network topology 325 is provided to and analyzed by the trained learning models 330 in connection with predicting device states, impacts of the device states, and trends associated with the impacts. The remediation plan generation engine 114 also analyzes the network topology 325 in connection with generating the remediation plan for the device(s) 122.

In stage 230, the device state chain model 332 (e.g., Markov chain machine learning model) predicts a device state such as a healthy state or an unhealthy state. For example, a device may be categorized as healthy or non-healthy, with the probability of the next state being predicted by the trained device state chain model 332. The trained device state chain model 332 can also be used to predict the time to reach the next state so that the duration to reach a future operational state can be specified in a generated remediation plan.

The device state impact model 334 (e.g., multiple linear regression machine learning model and/or time series forecasting model) predicts at least one impact of the future operational state determined by the device state chain model 332. In illustrative embodiments, if the predicted device state is unhealthy, the at least one impact of the future operational state comprises, for example, degraded performance, data loss and/or an increase in crash frequency of one or more devices.

In some embodiments, in connection with computing context-aware impact, the multiple linear regression machine learning model determines a mapping of device journey, device configuration, and device state to one or more impacts (e.g., degraded performance, data loss and/or an increase in crash frequency). The impact can be any target variable that impacts a computing environment or ecosystem. The multiple linear regression machine learning model is trained during stage 220 using multiple linear regression to determine the one or more impacts based on parameters such as, but not necessarily limited to, device configuration and device state. For example, the multiple linear regression model or other device state impact model 334 can determine whether a device 122 with a particular BIOS version will have performance degradation.

In illustrative embodiments, the multiple linear regression model evaluates a linear relationship between two or more explanatory variables and a response variable by fitting a linear equation to observed data.

For example, in the following formula (1), the target variable (Y) is a linear combination of multiple predictor variables x₁, x₂, x₃, . . . , xₙ.

Y=b₀x₀+b₁xz₁. . . bₙxₙ (1)

where: Y=output/response variable; b₀, b₁, b₂, b₃, bₙ=coefficients of the model; and x₁, x₂, x₃, xₙ.=various independent/feature variables.

In a non-limiting operational example, a device A performs at 90% of load (system resources) and has heavy network traffic while using non-recommended firmware on device components. In connection with determining impact, the device state impact model 334 uses an ARIMA model to predict degraded performance by showing a trend on the performance of the device by using ARIMA trend analysis. For a predicted count of frequent crashes, the device state impact model 334 uses the multiple linear regression model to determine a target variable. Data loss and frequent crashes are predicted using the trained multiple linear regression model.

The fix state impact model 336 (e.g., multiple linear regression machine learning model and/or time series forecasting model) predicts at least one trend associated with an impact determined by the device state impact model 334. As explained in more detail herein, the fix state impact model 336 determines a metric value (e.g., desired identifier value) for reducing the impact, and uses the time series forecasting machine learning model to compute a trend for reducing the impact based at least in part on the determined metric value. The fix state impact model 336 determines, for example, gains to a computing environment and/or ecosystem resulting from reducing (e.g., fixing) impacts such as, but not necessarily limited to, performance degradation, the number of crashes and the amount of data loss.

In more detail, in a non-limiting operational example, the predicted impact may be performance degradation. Trend analysis of performance degradation is determined using the ARIMA machine learning model to forecast time series data and perform statistical analysis. The ARIMA model utilizes a regression type equation in which the independent variables are lags of the dependent variable and/or lags of the forecast errors. In illustrative embodiments, a multivariate method of time series prediction is used to predict future values. In addition to previous values in the time series, the multivariate method also uses external variables to create a forecast.

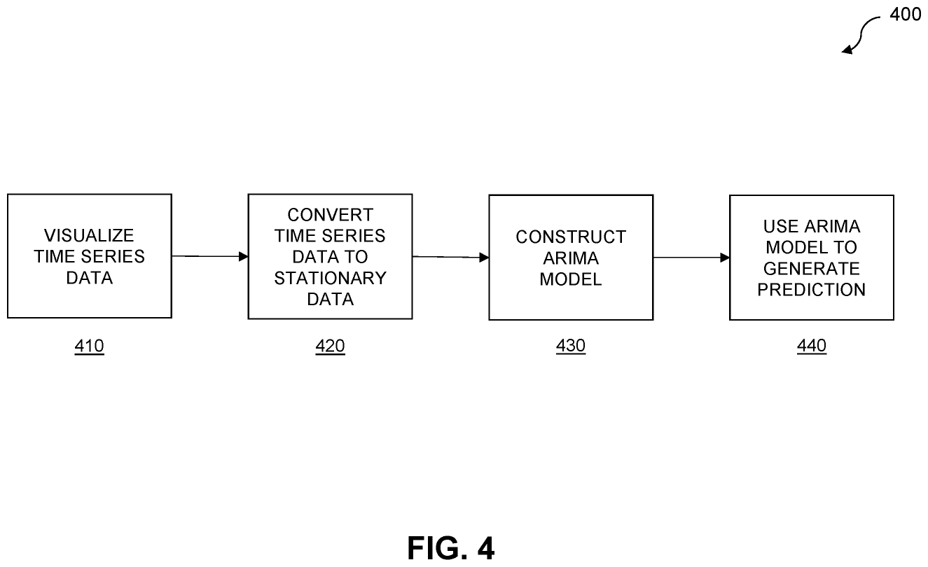

Referring to the operational flow 400 for time series forecasting in FIG. 4, time series forecasting includes visualizing the time series data (step 410), converting the time series data to stationary data (step 420), constructing the ARIMA model (step 430) and using the ARIMA model to generate a prediction (step 440). In connection with step 410, the fix state impact model 336 generates one or more of structured tables, one-dimensional plots of measurement times or values, color plots of measurement values, other types of plots (e.g., autocorrelation, seasonal subseries, spectral, bubble, scatter, line, step, smooth, etc.), charts (e.g., area, horizon, bar, etc.) and histograms to visualize the time series data.

In connection with step 420, the fix state impact model 336 identifies whether a data series is stationary or if there is significant seasonality. Seasonality can be identified through, for example, an autocorrelation plot, a plot or a spectral plot, which facilitate understanding of difference amounts and lag size. If the set of features used for training comprises non-stationary time series data, the non-stationary time series data is converted to stationary time series data. Referring to step 430, in constructing the ARIMA model, the ARIMA machine learning model is trained with the stationary time series data. The parameters of the model can be estimated using statistical software programs that utilize techniques such as, but not necessarily limited to, nonlinear least squares and maximum likelihood estimation. The model is validated in an iterative process through a series of trial-and-error runs, where re-training if the model is performed based on the accuracy of the model.

In connection with step 440, the fix state impact model 336 (e.g., multiple linear regression machine learning model and/or time series forecasting model) is used to predict a trend associated with an impact determined by the device state impact model 334. As noted above, the fix state impact model 336 determines a metric value (e.g., desired identifier value) for reducing an impact, and uses the time series forecasting machine learning model to compute a trend for reducing the impact based at least in part on the determined metric value. By feeding desired parameters to the trained fix state impact model 336, a desired identifier value (e.g., desired power consumption, desired performance (e.g., speed, throughput, latency, etc.)) can be determined. The trained fix state impact model 336 computes a trend for reducing the impact (e.g., performance degradation, number of crashes, data loss, etc.) based on the determined metric value (e.g., desired identifier value). For example, using the ARIMA model, a gain trend is determined with a desired identifier value and an existing identifier value.

In a non-limiting operational example, overall ecosystem impact is determined with an ARIMA model using desired identifier values for individual devices (e.g., devices 122). For example, overall ecosystem impact is equal to the sum of device D1 impact+device D2 impact+ . . . +device Dn impact. With a desired identifier for power consumption determined using the trained fix state impact model 336, the delta power consumption can be computed using the following formula (2):

Delta value=existing power consumption−desired power consumption (2)

With the delta value, the fix state impact model 336 computes a carbon footprint using the below formula (3):

Input value (in KWh/Yr)*0.85 (Emission Factor)=Output value (in kg of CO₂) (3)

In accordance with the above, illustrative embodiments are configured to predict environmental impacts. For example, the embodiments determine those devices with unsupported configurations that may consume excessive amounts of power, leading to an increased carbon footprint. The delta power consumption and the corresponding footprint at device and account levels can be provided to a user in a context-aware remediation plan.

Stage 240: Generating a context-aware remediation plan.

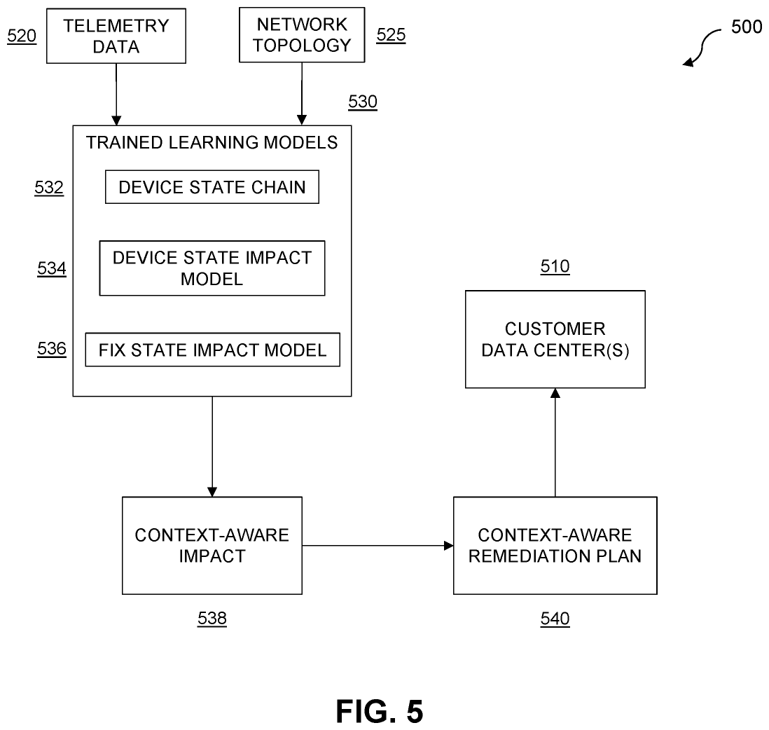

Referring to the operational flow 500 for remediation plan generation in FIG. 5, a context-aware remediation plan 540 is generated by the remediation plan generation engine 114 and transmitted to one or more customer data centers 510 or other type of customer computing environment. Based on telemetry data 520 and an identified network topology 525, the trained learning models 530 predict context-aware impact(s) and trend(s) 538, on which the context-aware remediation plan 540 is based. The trained learning models 530 include a device state chain model 532, a device state impact model 534 and a fix state impact model 536, which are the same as or similar to the device state chain model 332, device state impact model 334 and fix state impact model 336 discussed in connection with FIG. 3. In illustrative embodiments, the computed trends are for reducing at least one impact.

In illustrative embodiments, the context-aware remediation plan 540 includes a visualization of the network topology 525 (e.g., network topology diagram) to facilitate illustration of the impact of the unavailability of devices 122 due to, for example, deteriorated health or maintenance activity. In a non-limiting operational example, the visualization of the network topology 525 may show that device A is connected to a switch SW1 and to storage array E, and device B is connected to Switch SW2 and to storage array E. If storage array E has an issue with its operation, the impact of that issue to both devices A and B is shown in the visualization of the network topology 525. In some cases, with additional information about the devices A and B (e.g., network traffic), a user may reference the visualization of the network topology 525 and determine a number of request calls that may be affected by the issue.

Referring back to FIG. 1, the monitoring engine 112 and remediation plan generation engine 114 or components thereof may be implemented on the same processing platform or on respective distinct processing platforms, although numerous other arrangements are possible. The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the enterprise computing environment 110 and the customer computing environment 120 to reside in different data centers, and/or components of respective ones of the enterprise computing environment 110 and the customer computing environment 120 to reside in different data centers. Numerous other distributed implementations are possible. It is to be appreciated that the particular arrangement of the enterprise computing environment 110 and the customer computing environment 120 illustrated in the FIG. 1 embodiment is presented by way of example only, and alternative arrangements can be used in other embodiments. At least portions of the monitoring engine 112 and remediation plan generation engine 114 may be implemented at least in part in the form of software that is stored in memory and executed by a processor. At least portions of the monitoring engine 112 and remediation plan generation engine 114 or other portions of the information processing system 100, as will be described in further detail below, may be part of cloud infrastructure.

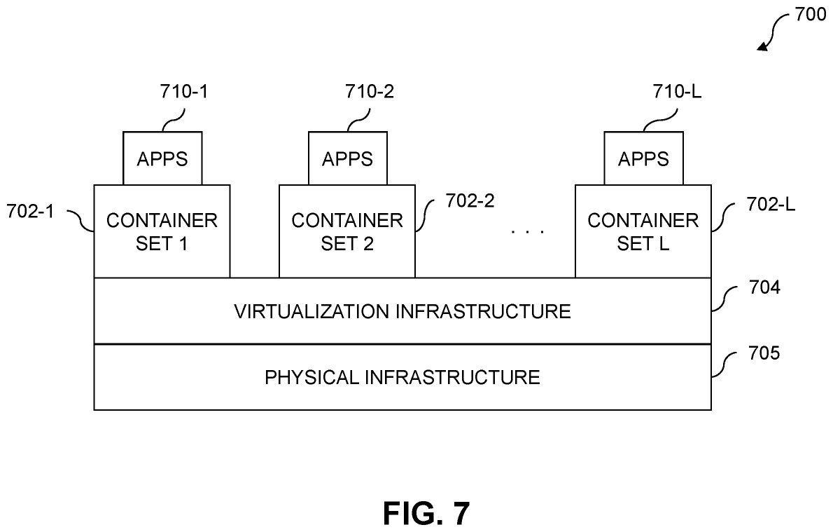

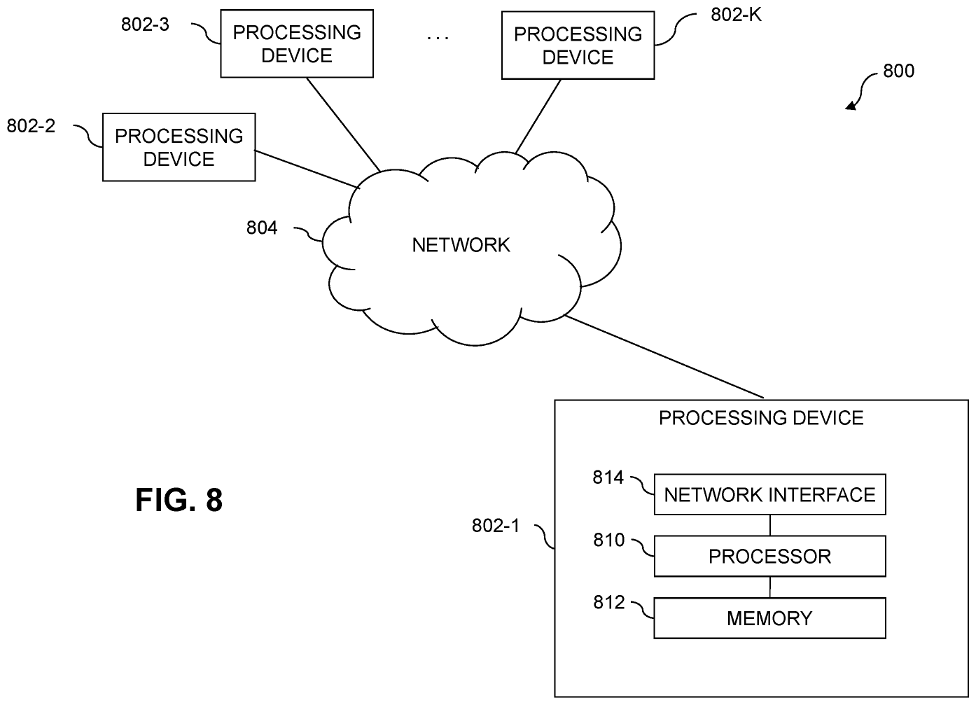

The monitoring engine 112 and remediation plan generation engine 114 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources. Additional examples of processing platforms utilized to implement the information processing system 100 in illustrative embodiments will be described in more detail below in conjunction with FIGS. 7 and 8.

It is to be understood that the particular set of elements shown in FIG. 1 is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

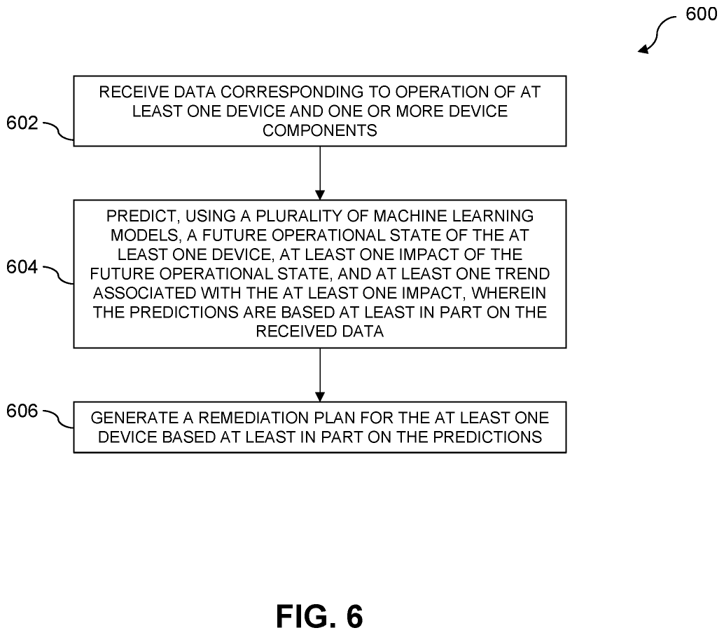

An exemplary process 600 for remediation plan generation in an information processing system will now be described in more detail with reference to the flow diagram of FIG. 6. It is to be understood that the process 600 is an example embodiment, and that additional or alternative processes for remediation plan generation may be used in other embodiments. It is to be further understood that, in some embodiments, the process 600 is implemented at least partially by the remediation plan generation engine 114 in the information processing system 100 of FIG. 1.

In this embodiment, the process 600 includes steps 602 through 606. As mentioned, in some embodiments, one or more of these steps are assumed to be performed by the remediation plan generation engine 114.

The process 600 begins with step 602, where data corresponding to operation of at least one device and one or more device components is received. In illustrative embodiments, the data corresponding to the operation of the at least one device and the one or more device components comprises at least one of CPU utilization, memory consumption, drive usage, device model, drive model, memory model and memory size.

In step 604, using a plurality of machine learning models, a future operational state of the at least one device, at least one impact of the future operational state, and at least one trend associated with the at least one impact are predicted. The predictions are based at least in part on the received data. In illustrative embodiments, the plurality of machine learning models are trained with at least a portion of the data corresponding to the operation of the at least one device and the one or more device components. In step 606, a remediation plan for the at least one device is generated based at least in part on the predictions.

In illustrative embodiments, predicting the future operational state of the at least one device comprises using a stochastic machine learning model to predict respective probabilities of one or more future operational states of the at least one device based on a most recent known operational state of the at least one device. Predicting the at least one impact of the future operational state comprises, for example, using a multiple linear regression machine learning model. The at least one impact of the future operational state may comprise at least one of degraded performance, data loss and an increase in crash frequency.

In illustrative embodiments, predicting the at least one trend associated with the at least one impact comprises, for example, using a time series forecasting machine learning model. The time series forecasting machine learning model may comprise an ARIMA machine learning model. The data corresponding to the operation of the at least one device and the one or more device components may comprise non-stationary time series data. According to one or more embodiments, the non-stationary time series data is converted to stationary time series data, and the ARIMA machine learning model is trained with the stationary time series data.

In illustrative embodiments, predicting the at least one trend associated with the at least one impact comprises determining a metric value for reducing the at least one impact, and using the time series forecasting machine learning model to compute a trend for reducing the at least one impact based at least in part on the determined metric value. The remediation plan is based at least in part on the computed trend for reducing the at least one impact. A visualization of a network topology can be generated based at least in part on the data corresponding to the operation of the at least one device and the one or more device components.

Illustrative embodiments overcome the above and other technical issues with existing approaches where static templates are used by providing techniques for remediation plan generation that use trained models to compute customer context-aware impact(s) and generate context-aware remediation plans, e.g., as disclosed above in process 600 of FIG. 6, for remediation plan generation in an information processing system. The embodiments advantageously collect and analyze telemetry data to understand a network topology. Models are trained to assess the impact of device issues on a customer ecosystem. A customer environment-aware report is generated, providing information on device availability, impact on dependent devices, and impact on consumers. By following the recommendations in the report, device performance can be optimized, and device downtime can be minimized.

The embodiments advantageously analyze data obtained from agents or other monitoring tools, generate a network topology for the monitored devices, and learn health status of the monitored devices. A feature set from the data is auto encoded and models are trained. With the trained models, customer context-aware impact(s) is computed and a context-aware remediation plan is generated. The remediation plan can then be sent to the customer.

The enterprise framework of the illustrative embodiments advantageously analyzes a customer environment to generate network topology diagram and trains a plurality of machine learning models with portions of collected telemetry data from devices. Future device states are predicted using a Markov chain model. With the predicted next state, the machine learning models predict device state impact and fix state impact. Based on these predictions, a context-aware remediation plan is generated and transmitted to a user. The embodiments are able to predict data loss, crash frequency and degraded performance in devices located in externally networked systems.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionalities for remediation plan generation will now be described in greater detail with reference to FIGS. 7 and 8. Although described in the context of information processing system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100 in FIG. 1. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. A hypervisor platform may be used to implement a hypervisor within the virtualization infrastructure 704, where the hypervisor platform has an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of information processing system 100 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionalities described herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, enterprise computing environments, customer computing environments, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured to:
receive data corresponding to operation of at least one device and one or more device components;
predict, using a plurality of machine learning models, a future operational state of the at least one device, at least one impact of the future operational state, and at least one trend associated with the at least one impact, wherein the predictions are based at least in part on the received data; and
generate a remediation plan for the at least one device based at least in part on the predictions.

2. The apparatus of claim 1, wherein the data corresponding to the operation of the at least one device and the one or more device components comprises at least one of central processing unit utilization, memory consumption, drive usage, device model, drive model, memory model and memory size.

3. The apparatus of claim 2, wherein the at least one processing device is further configured to train the plurality of machine learning models with at least a portion of the data corresponding to the operation of the at least one device and the one or more device components.

4. The apparatus of claim 1, wherein, in predicting the future operational state of the at least one device, the at least one processing device is configured to use a stochastic machine learning model to predict respective probabilities of one or more future operational states of the at least one device based on a most recent known operational state of the at least one device.

5. The apparatus of claim 1, wherein, in predicting the at least one impact of the future operational state, the at least one processing device is configured to use a multiple linear regression machine learning model.

6. The apparatus of claim 1, wherein the at least one impact of the future operational state comprises at least one of degraded performance, data loss and an increase in crash frequency.

7. The apparatus of claim 1, wherein, in predicting the at least one trend associated with the at least one impact, the at least one processing device is configured to use a time series forecasting machine learning model.

8. The apparatus of claim 7, wherein the time series forecasting machine learning model comprises an autoregressive integrated moving average machine learning model.

9. The apparatus of claim 8, wherein the data corresponding to the operation of the at least one device and the one or more device components comprises non-stationary time series data, and the at least one processing device is further configured to:
convert the non-stationary time series data to stationary time series data; and
train the autoregressive integrated moving average machine learning model with the stationary time series data.

10. The apparatus of claim 7, wherein, in predicting the at least one trend associated with the at least one impact, the at least one processing device is further configured to:
determine a metric value for reducing the at least one impact; and
use the time series forecasting machine learning model to compute a trend for reducing the at least one impact based at least in part on the determined metric value.

11. The apparatus of claim 10, wherein the remediation plan is based at least in part on the computed trend for reducing the at least one impact.

12. The apparatus of claim 1, wherein the at least one processing device is further configured to generate a visualization of a network topology based at least in part on the data corresponding to the operation of the at least one device and the one or more device components.

13. A computer program product comprising a non-transitory processor-readable storage medium having stored therein program code of one or more software programs, wherein the program code when executed by at least one processing device causes the at least one processing device to:
receive data corresponding to operation of at least one device and one or more device components;
predict, using a plurality of machine learning models, a future operational state of the at least one device, at least one impact of the future operational state, and at least one trend associated with the at least one impact, wherein the predictions are based at least in part on the received data; and
generate a remediation plan for the at least one device based at least in part on the predictions.

14. The computer program product of claim 13, wherein, in predicting the future operational state of the at least one device, the program code when executed by the at least one processing device causes the at least one processing device to use a stochastic machine learning model to predict respective probabilities of one or more future operational states of the at least one device based on a most recent known operational state of the at least one device.

15. The computer program product of claim 13, wherein, in predicting the at least one trend associated with the at least one impact, the program code when executed by the at least one processing device causes the at least one processing device to use a time series forecasting machine learning model.

16. The computer program product of claim 15, wherein, in predicting the at least one trend associated with the at least one impact, the program code when executed by the at least one processing device further causes the at least one processing device to:
determine a metric value for reducing the at least one impact; and
use the time series forecasting machine learning model to compute a trend for reducing the at least one impact based at least in part on the determined metric value.

17. A method comprising:
receiving data corresponding to operation of at least one device and one or more device components;
predicting, using a plurality of machine learning models, a future operational state of the at least one device, at least one impact of the future operational state, and at least one trend associated with the at least one impact, wherein the predictions are based at least in part on the received data; and
generating a remediation plan for the at least one device based at least in part on the predictions;
wherein the method is performed by at least one processing device comprising a processor coupled to a memory.

18. The method of claim 17, wherein predicting the future operational state of the at least one device comprises using a stochastic machine learning model to predict respective probabilities of one or more future operational states of the at least one device based on a most recent known operational state of the at least one device.

19. The method of claim 17, wherein predicting the at least one trend associated with the at least one impact comprises using a time series forecasting machine learning model.

20. The method of claim 19, wherein predicting the at least one trend associated with the at least one impact further comprises:
determining a metric value for reducing the at least one impact; and
using the time series forecasting machine learning model to compute a trend for reducing the at least one impact based at least in part on the determined metric value.
